(19) United States
(12) Patent Application Publication
(10) Pub. No.: US 2014/0046681 A1
(43) Pub. Date: Feb. 13, 2014

(54) Response Message Normalization System

(71) Applicant: ZIRMED, INC., Louisville, KY (US)

(72) Inventors: Douglas Roy Fielding, Finchville, KY (US); James Scott Lacy, Shelbyville, KY (US); Christopher Lawrence Schremser, New Albany, IN (US); Bryan Lee Cruise, Louisville, KY (US); Robin Sue Harrison, Clearfield, UT (US)

(73) Assignee: ZIRMED, INC., Louisville, KY (US)

(21) Appl. No.: 13/966,232

(22) Filed: Aug. 13, 2013

Related U.S. Application Data
(60) Provisional application No. 61/682,755, filed on Aug. 13, 2012.

(51) Int. Cl. G06F 19/00

(52) U.S. Cl. CPC G06F 19/328
USPC 705/2

(57) ABSTRACT

A method for normalizing messages received in response to transaction submissions is provided. The method includes receiving a plurality of messages regarding the outcome of transaction submissions; normalizing each received message; linking the normalized message to an internal message that reflects the meaning of the received message; and retaining the transaction-specific elements of the received message in a separate, distinct location.

### CROSS-REFERENCE TO RELATED APPLICATIONS

This application claims priority to U.S. Ser. No. 61/682,755 (Fielding et al.), entitled “RESPONSE MESSAGE NORMALIZATION SYSTEM”, which was filed on Aug. 13, 2012, and which is incorporated herein by reference in its entirety.

### FIELD OF THE DISCLOSURE

The present disclosure relates generally to healthcare revenue cycle management, and more particularly to systems and methods for normalizing responses received from payers in response to transaction submissions.

### BACKGROUND OF THE DISCLOSURE

In a typical healthcare revenue cycle, claims are submitted to insurance companies or other payers by healthcare service providers, either directly or via a healthcare revenue cycle management company which is associated with the healthcare provider. Acknowledgements are received in response to those claims. These acknowledgements may contain codifies or textual descriptions of the outcome of the claim. In particular, these acknowledgements frequently articulate one or more reasons why the claim is being rejected, but may also include acceptance messages or warning messages relating to the submitted claim.

### BRIEF DESCRIPTION OF THE DRAWINGS

FIG. 1 is a flowchart of a message processing system in accordance with the teachings herein.

FIG. 2 is a flowchart of a message mapping system in accordance with the teachings herein.

FIG. 3 is an illustration of a system for processing messages in accordance with the teachings herein.

FIG. 4 is an illustration of a typical revenue cycle in the healthcare industry.

### SUMMARY OF THE DISCLOSURE

In a preferred embodiment, the systems and methodologies disclosed herein provide a business solution (preferably implemented as a software solution) that allows billers and coders to rapidly understand and correct rejected healthcare claims (such as, for example, submitted claims for healthcare insurance coverage which have been rejected by an insurer) by translating the complex and often cryptic messages which frequently accompany a claim rejection into plain (and preferably standardized) language that is more readily understood.

At present, a healthcare provider may interface with thousands of insurance companies. However, each insurance company may use its own language in claim rejection messages, and a given company may even change this language from time to time. Consequently, there are currently tens of thousands of different messages that may describe the same underlying reason for a claim rejection. The processing of these different messages consumes valuable time in the healthcare revenue cycle and delays the reimbursement process.

In a preferred embodiment, the systems and methodologies disclosed herein provide easy-to-understand “translations” of claim rejection messages, including both a simplified message and one-click access to the original payer-generated notification for reference. Thus, the systems and methodologies disclosed herein map hundreds of variations of the same core reason for claim rejection into a single, simplified message, thus allowing users to learn and recognize core issues more rapidly.

In a preferred embodiment, the systems and methodologies disclosed herein also allow for fast resolution of issues by providing guided navigation within a claim edit screen to advise users exactly where to resolve the underlying rejection issue. Specific fields on the screen may be highlighted and, to make sure users know exactly how to address a simplified rejection message, detailed step-by-step instructions (preferably from a knowledge base) are linked to the simplified response.

Various aspects of the systems and methodologies may be noted. Thus, in one aspect, a method for normalizing messages is provided. The method comprises (a) receiving a plurality of messages regarding the outcome of transaction submissions; (b) normalizing each received message; (c) linking the normalized message to an internal message that reflects the meaning of the received message; and optionally (d) retaining the transaction-specific elements of the received message in a separate, distinct location.

In another aspect, a method for establishing the linkage of a normalized message to an internal message is provided. The method comprises (a) articulating text manipulation logic for extracting transaction-specific information from a raw message to arrive at a normalized message; (b) matching normalized messages to internal messages; (c) establishing attributes of internal messages; and (d) establishing attributes of data fields.

In a further aspect, a tangible, non-transitory, computer readable medium is provided which contains suitable programming instructions which, when executed by at least one computational device, cause the at least one computational device to perform any of the foregoing methods.

### DETAILED DESCRIPTION

Managing claim submission acknowledgements is a considerable expense for healthcare service providers and healthcare revenue cycle management companies. In particular, such entities must typically interact with a variety of different payers. Each payer typically has its own unique messages which it generates in response to submitted claims. Indeed, the messages generated by a particular payer may vary over time, even for the same type of claim, problem or issue. Consequently, significant amounts of time are spent by healthcare service providers and healthcare revenue cycle management companies simply in tying different articulations of an issue related to a submitted claim to the same underlying problem. There is thus a need in the art to normalize these messages so that messages relating to the same type of issue may be similarly categorized, even if the issue is articulated differently from one message to another.

It has now been found that the foregoing needs may be met with the systems and methodologies disclosed herein. In a preferred embodiment of these systems and methodologies, messages related to a submitted claim or other transaction are received in electronic form. These messages are then systematically extracted and attributed to the applicable claims. In particular, these raw, inbound response messages from payers and other third-party entities are normalized (stripped of their claim-specific data), and then mapped to internal friendly messages that have been carefully crafted to articulate a standardized, friendly way to convey the message in a uniform manner.

Each internal friendly message may have certain attributes to it. Such attributes may include the type of message (acknowledgement, acceptance, rejection, warning, or the like), a categorization of the message (coding, patient demographics, eligibility, claim information, provider enrollment, or the like), a knowledgebase article that can give specific instructions on what to do about the situation to which the message applies, or a field.

A field represents a data element of a claim transaction to which the message applies. Fields may be associated with their location in a number of different representations of the claim, including the field location on a paper-based claim form (i.e. CMS-1500 or UB-04 claim form), the field location in the ANSI X12 837 EDI transaction, the field location in the online claim edit screen of the revenue cycle management company, or the like.

The foregoing process of associating external, raw, normalized messages to internal friendly messages, and the further association of each internal friendly message to various attributes, offers a number of advantages. For example, such a process enables healthcare revenue cycle management companies to offer a variety of new business solutions to their clients. In particular, this process, and the information generated by it, may be utilized to substantially enhance the functionality and benefit of software solutions for the clients of the revenue cycle management company.

One advantage of some of the systems and methodologies disclosed herein is the ability they provide to present a clear, standardized, friendly response message to the user. By contrast, as noted above, conventional systems and methodologies in the art frequently yield varying, oftentimes complicated messages that are returned on claim acknowledgement transactions from payers or third-party clearinghouses.

A further advantage of some of the systems and methodologies disclosed herein is the ability they provide to report on, and to analyze, the various types of responses received.

Another advantage of some of the systems and methodologies disclosed herein is the ability they provide to create knowledgebase articles for each individual response scenario, and the ability to give clear directions to users for what actions to take in each scenario.

Still another advantage of some of the systems and methodologies disclosed herein is the ability they provide to associate support cases with a specific, internal friendly message from a claim.

Yet another advantage of some of the systems and methodologies disclosed herein is the ability they provide to revenue cycle management companies to develop and release task management solutions that tie tasks directly to an internal friendly message. Such solutions may include workflow automation that relies on the attributes of the internal friendly message, such as category, claim type, claim field location, claim edit screen field location, and the like.

Another advantage of some of the systems and methodologies disclosed herein is the ability they provide to revenue cycle management companies to develop and release analytics solutions that give visibility and intelligence of the types of responses being realized by a client, and the ability to create targeted, action-oriented business intelligence solutions for improving business processes.

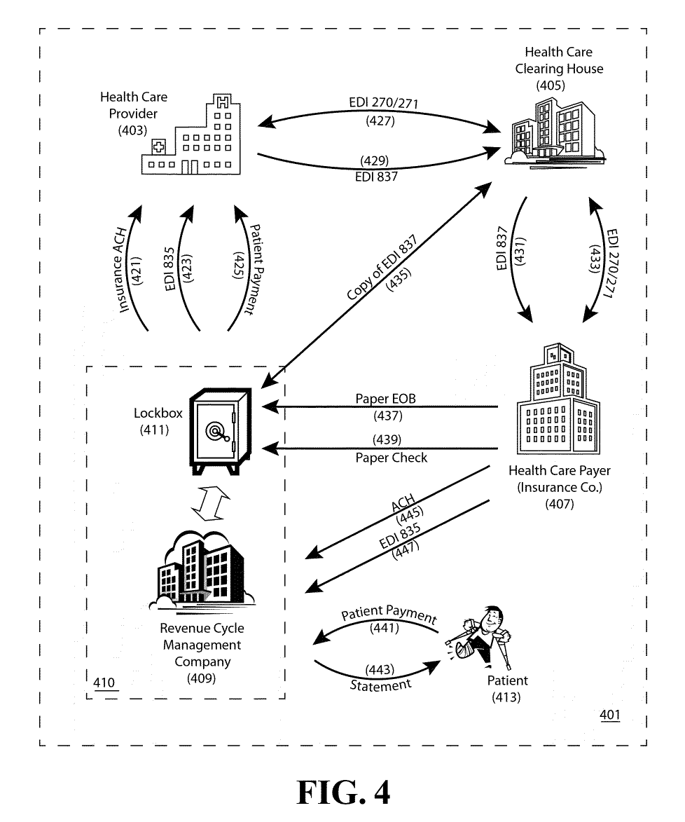

The systems and methodologies disclosed herein relate to the healthcare revenue cycle and to the handling of claims and remittances within the healthcare revenue cycle. Hence, these systems and methodologies may be better understood by first considering the conventional manner, indicated in FIG. 4, in which claims and remittances are typically handled in the healthcare industry today. The major entities in this system 401 include healthcare service providers 403, clearing houses 405, healthcare payers 407, revenue cycle management companies 409, and patients 413. Each of the revenue cycle management companies 409 may have an associated lockbox 411 (which will typically be provided by a bank or financial institution) for the receipt of forms and remittance. Of course, it will be appreciated that the depicted system has been simplified for ease of illustration, and that a typical, real-life example of the foregoing type of system may have potentially large numbers of parties of each of the foregoing type.

The healthcare service provider 403 may be, for example, a hospital, a physician's office, an urgent care center, a testing facility or lab, or any other organization that provides healthcare services, treatment, or associated services for patients and then bills for those services. The healthcare payer 407 is typically an insurance company or a related entity that provides insurance coverage for patients.

The revenue cycle management company 409 may be a healthcare information technology company that provides web-based revenue cycle management software solutions for healthcare service providers, and/or may be a healthcare clearing house as defined by HIPAA. Such a company may offer eligibility verification, credit/debit card processing, check processing, claims management, coding compliancy and reimbursement management, patient statements, patient e-commerce, and provider credentialing solutions, as well as electronic remittance advice and patient billing services.

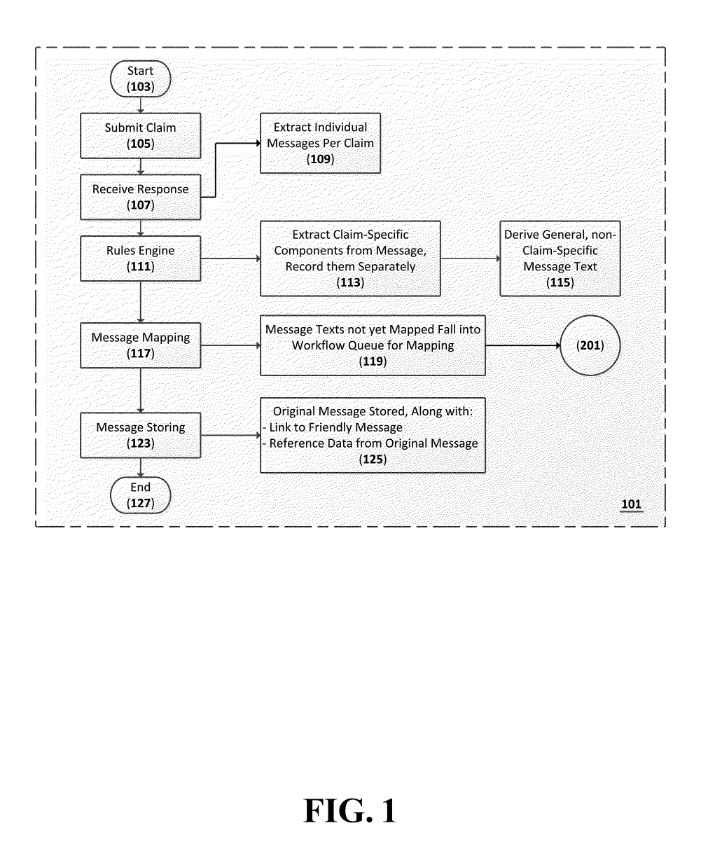

The clearing house 405 is typically an organization that transfers transaction files between the healthcare payer 407 and the healthcare service provider 403. Although depicted in FIG. 1 as a separate entity, in practice, it may be part of the revenue cycle management company 409.

The interaction between the foregoing entities may be understood by considering the manner in which claims are handled in the healthcare industry. When a healthcare provider 403 provides healthcare services to a patient 413 (such as, for example, treatment of a broken leg), the healthcare provider 403 issues an electronic claim 429 to a healthcare clearinghouse 405 for any portion of the services that were not paid for by the patient 413 at the time the services are rendered. The electronic claim is submitted in a HIPAA-compliant 837 format such as, for example, the HIPAA-compliant X12N 837 version 5010 format. The healthcare provider 403 and the healthcare clearing house 405 also exchange a healthcare eligibility inquiry and response 427 by way of an EDI (electronic data interchange) 270 and 271, respectfully.

The EDI 270 Health Care Eligibility/Benefit Inquiry transaction set is used to request information from a healthcare insurance plan about the coverage afforded by a policy, typically in relation to a particular plan subscriber. The 270 transaction is typically used for inquiries about what services are covered for particular patients (policy subscribers or their dependents), including required copays or coinsurance. It may also be used to inquire about general information on coverage and benefits, or for questions about the coverage of specific benefits for a given plan, such as wheelchair rental information, diagnostic lab services, physical therapy services, and the like. The 270 document typically includes details of the sender of the inquiry (name and contact information of the information receiver), the name of the recipient of the inquiry (the information source), details of the plan subscriber about to the inquiry is referring, and a description of eligibility or benefit information requested.

The EDI 271 is the Health Care Eligibility/Benefit Response and is used to transmit the information requested in n EDI 270. The EDI 271 may include such information as eligibility status, maximum benefits (policy limits), exclusions, in-plan/out-of-plan benefits, C.O.B. information, deductibles, co-pays, procedure coverage dates, procedure coverage maximum amount(s) allowed, deductible amount(s), remaining deductible amount(s), co-insurance amount(s), co-pay amount(s), coverage limitation percentages, patient responsibility amount(s) and non-covered amount(s).

The healthcare clearing house 405 then transmits a copy of the EDI 837 431 and the EDI 270/271 Health Care Eligibility/Benefit Inquiry transaction set 433 to the healthcare payer 407, and further transmits a copy of the EDI 837 435 to the revenue cycle management company 410. The healthcare payer 407 then sends paper check payments 439, along with an EOB (Explanation of Benefits) 437, to a revenue cycle management company 410 or a lockbox 411 associated therewith, or else sends an ACH payment 445 (an electronic payment made through the Automated Clearing House) and electronic remittance advice (ERA) in an EDI 835 447 (currently ANSI X12 835).

The revenue cycle management company 410 sends a statement 443 to the patient 413, and receives payment 441 from the patient 413. The revenue cycle management company 410 then sends any patient payments 425 it receives, along with any ACH payment 421 received from the healthcare payer 407 and a copy of the EDI 835 423, to the healthcare provider 403.

It will be appreciated from the foregoing that the typical healthcare revenue cycle involves claims which are submitted to insurance companies or other payers by healthcare service providers, either directly or via a healthcare revenue cycle management company which is associated with the healthcare provider. It will further be appreciated that acknowledgements or responses are received in response to those claims. These responses may contain codifies or textual descriptions of the outcome of the claim. In particular, these responses frequently articulate one or more reasons why the claim is being rejected, but may also include acceptance messages or warning messages relating to a submitted claim.

The manner in which these responses are handled may be further understood with reference to the particular, non-limiting embodiment of the message processing system depicted in FIG. 1. As seen therein, the process 101 embodied in the system commences 103 with the submission of a transaction 105. In due course, a response to the transaction is received 107 from a payer or other party. Individual messages are extracted 109 from each response.

Next, a rules engine 111 is utilized to extract transaction-specific components from the message 113 and record them separately. Normalized message text that is not transaction specific is then derived 115.

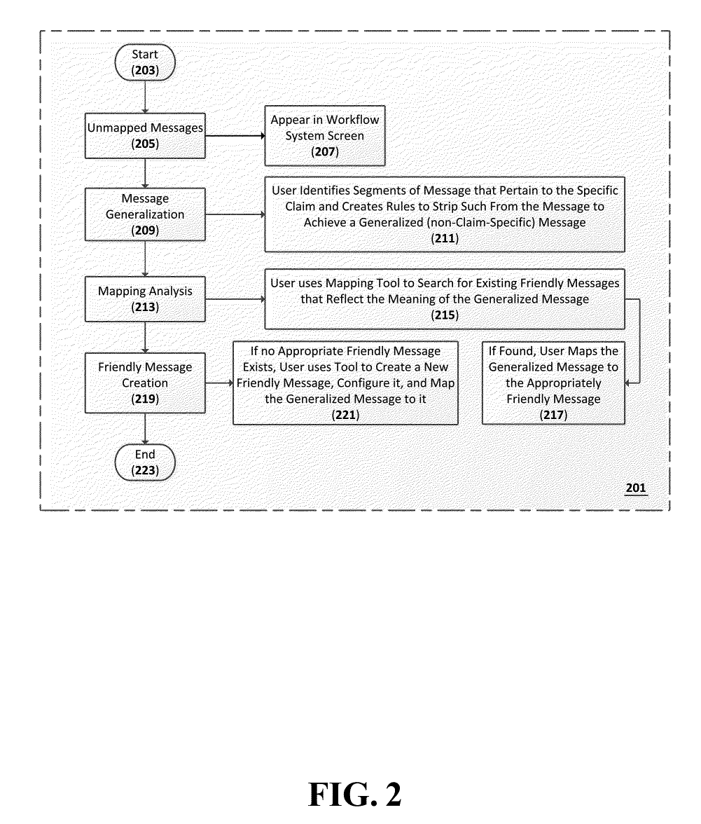

The message is then subjected to message mapping 117. In this process, message texts which are not yet mapped fall into a workflow queue 119 for mapping. The message texts are then subjected to the mapping process 201 depicted in FIG. 2.

Subsequent to mapping, the messages are stored 123. This process involves storing the original message 125, along with (i) a link to an internal message, and (ii) reference data from the original message. The message processing process then terminates 127.

In the foregoing system, the submitted transaction will typically be an insurance claim, which may be submitted by a healthcare provider (or healthcare clearing house) to an insurance company or other healthcare payer. However, the system may be utilized with various other types of transactions. Such transactions may include, for example, various EDI-type or non-EDI-type structured or unstructured system messages, X12 transactions (such as, for example, 837, 835, 277, 278, 270, 271, 276 or 275 transactions or the like), HL7 transactions (such as, for example, ADT, charges, appointments, referrals, medical results, orders, transcriptions, or the like), DICOM (Digital Imaging and Communications in Medicine, a standard for handling, storing, printing, and transmitting information in medical imaging that includes a file format definition and a network communications protocol), proprietary transactions, and various other transaction types.

FIG. 2 depicts a particular, non-limiting embodiment of a message mapping process in accordance with the teachings herein. The process 201 depicted therein commences 203 when messages processed by the system in FIG. 1 are passed to the message mapping system (see step 201 in FIG. 1). The unmapped messages 205 are received and appear in a workflow system screen 207. Each message is subjected to a message normalization step 209. In this step, segments of the message are identified 211 that pertain to the specific transaction, and rules are created as necessary to strip transaction specific segments from the message, thereby obtaining a normalized message that is not transaction-specific.

A mapping analysis 213 is then undertaken in which a mapping tool is utilized 215 that searches for existing internal messages that reflect the meaning of the normalized message. If such a message is found, the normalized message is mapped 217 to the appropriate internal message.

If no such message is found, an internal message is created 219. In this process, a tool is utilized to create 221 a new internal message, configure it, and map the normalized message to it. The message mapping process then terminates 223.

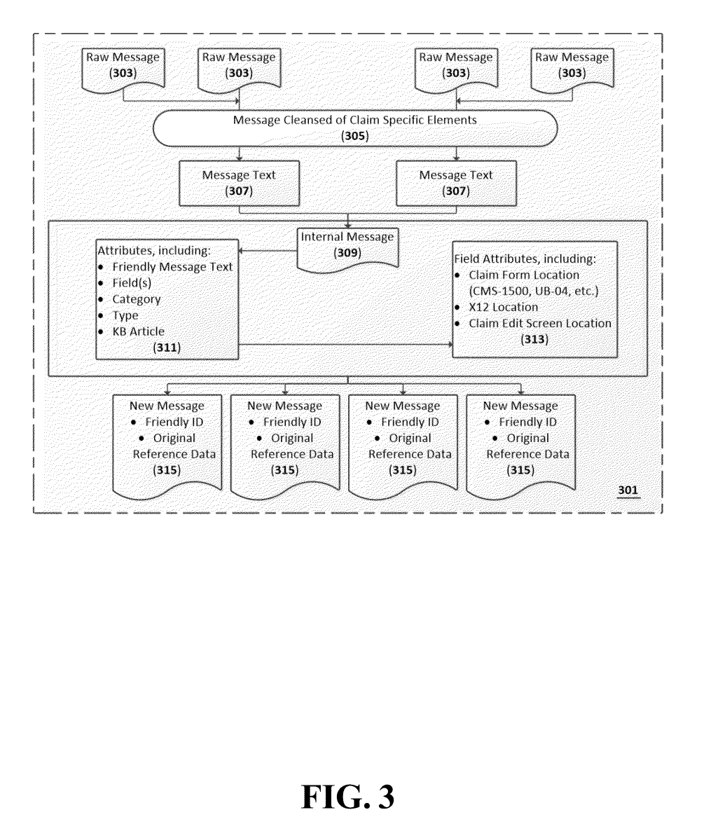

FIG. 3 illustrates a particular, non-limiting embodiment of an overall process by which raw messages are converted into normalized messages in accordance with the teachings herein. As seen therein, in the system 301 depicted, a plurality of raw messages 303 are received. The messages are then subjected to processes described above to cleanse the messages of transaction-specific elements 305, thereby yielding message texts 307.

The message texts are then mapped to an internal message 309 having various attributes 311. These attributes may include a friendly message text, message fields, message categories, message type, and knowledgebase article. The internal message may be further characterized by various field attributes 313, including claim form location (e.g., CMS-1500, UB-04, etc.), X12 transaction location, and claim edit screen location. A plurality of new messages 315 may then be generated, each of which includes an internal message ID, and original reference data 317.

In some embodiments of the systems and methodologies disclosed herein, a claim edit screen may be provided from which rejected claims may be edited. In some such embodiments, the rejected claims may be divided into fields, and various messages may be associated with any of the fields. Such messages may include, for example, the original message received from the party denying the claim, a normalized version of the original message in which claim specific components of the message have been extracted, or a standardized version of the original or normalized messages. In some implementations, fields having a message associated with them may be highlighted, and the system may be adapted to auto-navigate to the first field having an associated message. Hotlinks or other features may be provided to allow a user to navigate between the fields and any of the foregoing message types.

In some embodiments of the systems and methodologies disclosed herein, screens or APIs may be provided where a message may be represented that is attributable to a particular transaction. For example, such a screen may be a claim-edit screen, a claims-listing screen, or a claim history screen. The transaction-specific information may be reassembled with an internal or standardized message to show a complete message applicable to that transaction.

Some embodiments of the systems and methodologies disclosed herein may be provided with a knowledge database. Such embodiments may be equipped with a “How to Fix” button or other such feature which pulls up (e.g., which is hot-linked to) a knowledge database article identified as an attribute to the internal or standardized message, and which tells the user how to fix the problem.

In some embodiments of the systems and methodologies disclosed herein, the user is provided with navigational means which allows the user to view any messages related to a transaction. Thus, for example, the user may be given the ability to browse the original raw message, the friendly re-assembled message, or the standardized message related to a transaction.

In some embodiments of the systems and methodologies disclosed herein, these systems and methodologies may be adapted to convey messages in particular formats using information available from internal data fields generated during message normalization. For example, these systems and methodologies may be adapted to generate messages as codified EDI transactions (such as an X12 277 transaction) using attributes of the internal message data fields. These internal message data fields and other attributes may also be utilized to execute workflow management and work distribution, or to report or analyze transaction outcomes.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended transactions.

What is claimed is:

1. A tangible, non-transitory, computer readable medium which contains suitable programming instructions which, when executed by at least one computational device, causes the at least one computational device to perform a method for processing messages received from healthcare payers, the method comprising:
receiving a plurality of messages from a plurality of healthcare payers, wherein each message regards the outcome of a healthcare transaction submitted to one of the plurality of healthcare payers;
normalizing each of the plurality of received messages by extracting transaction-specific elements therefrom, thereby generating a plurality of corresponding normalized messages; and
linking each of the plurality of normalized messages to a standardized message that reflects the meaning of the received message corresponding to each normalized message.

2. The method of claim 1, wherein the healthcare transaction is an insurance claim.

3. The method of claim 1, further comprising:
retaining the transaction-specific elements of the received message in a separate location from the plurality of normalized messages.

4. The method of claim 3, wherein the separate location is a separate file.

5. The method of claim 3, wherein the separate location is a separate row, column or cell in a table.

6. The method of claim 1, wherein each message (a) is generated in response to an insurance claim submitted to one of the plurality of healthcare payers, and (b) regards the outcome of the insurance claim submission.

7. The method of claim 5, wherein each normalized message is recorded in a table and given a unique identifying ID.

8. The method of claim 6, wherein normalizing each of the plurality of received messages involves the application of a rules engine.

9. The method of claim 1, wherein the transaction-specific information from each received message is extracted and stored in a discrete location which is applicable to the message event.

10. The method of claim 1, wherein normalized messages not linked to a standardized message are placed in a workflow queue for further processing.

11. The method of claim 1, wherein each healthcare transaction is a rejected insurance claim, and wherein each of the plurality of messages contains at least one reason for the rejection of the insurance claim.

12. The method of claim 11, further comprising:
dividing each of the plurality of claims into a plurality of fields;
rendering the plurality of fields on a display; and
associating each of the standardized messages corresponding to a claim with one of said plurality of fields.

13. The method of claim 12, further comprising:
highlighting each field which has a standardized message associated with it.

14. The method of claim 12, further comprising:
automatically navigating to the first of said plurality of fields which has a standardized message associated with it.

15. The method of claim 12, wherein each of the plurality of fields is editable.

16. The method of claim 12, further comprising:
displaying the transaction specific elements extracted from a message with the standardized message associated with the message.

17. The method of claim 12, further comprising:
displaying an error correction icon which is associated with the standardized message, wherein the error correction icon is hotlinked to an entry in a knowledge database which explains how to correct the error.

18. The method of claim 1, further comprising:
linking each of the plurality of normalized messages to the message from which the normalized message was derived.

19. The method of claim 18, wherein linking each of the plurality of normalized messages to the original message from which the normalized message was derived includes creating a first hotlink between the normalized message and the corresponding original message.

20. The method of claim 1, further comprising:
linking each original message from which one of said plurality of normalized messages was derived to one of said standardized messages.

21. The method of claim 20, wherein linking each original message from which one of said plurality of normalized messages was derived to one of said standardized messages includes creating a first hotlink between the original message and the corresponding standardized message.

22. A tangible, non-transitory, computer readable medium which contains suitable programming instructions which, when executed by at least one computational device, causes the at least one computational device to perform a method for establishing the linkage of a normalized message to an internal message, the method comprising:
articulating text manipulation logic for extracting transaction-specific information from a raw message to arrive at a normalized message;
matching normalized messages to internal messages;
establishing attributes of internal messages; and
establishing attributes of data fields.

23. The method of claim 22, wherein articulating the text manipulation logic for deriving normalized messages consists of creating reusable pattern-matching rules.

24. The method of claim 22, further comprising:
performing matching from a workflow queue.

25. The method of claim 22, further comprising:
searching for possible existing internal messages to which a normalized message might apply.

26. The method of claim 22, further comprising:
establishing a link from a normalized message to an existing internal message.

27. The method of claim 22, further comprising:
creating a new internal message; and
linking a normalized message to the new internal message.

28. The method of claim 22, further comprising:
establishing attributes of internal messages, including friendly message text, message type, message category, knowledgebase article address, and at least one data field.

29. The method of claim 22, further comprising:
establishing attributes of data fields, including claim form location, X12 transaction data field location, 277 transaction field identifier codes, and claim edit screen location.

30. A method for processing messages received from healthcare payers, comprising:
receiving a plurality of messages from a plurality of healthcare payers, wherein each message regards the outcome of a healthcare transaction submitted to one of the plurality of healthcare payers;
normalizing each of the plurality of received messages by extracting transaction-specific elements therefrom, thereby generating a plurality of corresponding normalized messages; and
linking each of the plurality of normalized messages to a standardized message that reflects the meaning of the received message corresponding to each normalized message.
